(19) United States
(12) Patent Application Publication
(10) Pub. No.: US 2024/0405255 A1
(43) Pub. Date: Dec. 5, 2024

(54) BATTERY CELL, BATTERY, AND ELECTRICAL DEVICE

(71) Applicant: Ningde Amperex Technology Limited, Ningde (CN)

(72) Inventor: Weijia PENG, Ningde (CN)

(73) Assignee: Ningde Amperex Technology Limited, Ningde (CN)

(21) Appl. No.: 18/799,166

(22) Filed: Aug. 9, 2024

Related U.S. Application Data
(63) Continuation of application No. PCT/CN2022/075852, filed on Feb. 10, 2022.

(51) Int. Cl. H01M 10/04; H01M 4/02; H01M 4/62

(52) U.S. Cl. CPC H01M 10/0431; H01M 4/621; H01M 2004/021

(57) ABSTRACT

A battery cell includes a first electrode plate which includes a first current collector and a first active material layer. The first current collector includes a first surface. The first active material layer includes a first part and a second part. A first groove is formed between the first part and the second part to expose the first surface. Along a first direction, a first thinned region is disposed at a position adjacent to the first groove in the first part, and a second thinned region is disposed at a position adjacent to the first groove in the second part. A thickness of the second thinned region is greater than a thickness of the first thinned region. The battery cell further includes a first adhesive layer which extends from the first thinned region to the second thinned region. A part of the first adhesive layer covers the first groove.

### CROSS REFERENCE TO RELATED APPLICATION

This application is a continuation application of International Application No. PCT/CN2022/075852, filed on Feb. 10, 2022, the contents of which are incorporated herein by reference in its entirety.

### TECHNICAL FIELD

This application relates to the field of battery technology, and in particular, to a battery cell, a battery, and an electrical device.

### BACKGROUND

In a production process of batteries, a tab groove is usually provided on an active material layer of an electrode plate so that a tab is fixed in the long tab groove to reduce accumulation of the thickness of the tab. The tab groove is typically made by intermittent coating. Due to a thinning mechanism different between the head and the tail of the active material layer, the thinning at the head is less controllable than the thinning at the tail. Consequently, the thickness of at least one of the active material layers on two sides of the tab groove is abnormal, and lithium plating occurs at the position where the thickness is abnormal.

### SUMMARY

In view of the above situation, it is necessary to provide a battery cell to reduce the risk of lithium plating.

An embodiment of this application provides a battery cell, including a first electrode plate. The first electrode plate includes a first current collector and a first active material layer. The first current collector includes a first surface. The first active material layer includes a first part and a second part. A length direction of the first current collector unwound is a first direction. The first part and the second part are disposed apart on the first surface along the first direction. A first groove is formed between the first part and the second part to expose the first surface. Along the first direction, a first thinned region is disposed at a position adjacent to the first groove in the first part, and a second thinned region is disposed at a position adjacent to the first groove in the second part. A thickness direction of the first current collector is a second direction. Along the second direction, a thickness of the second thinned region is greater than a thickness of the first thinned region. The battery cell further includes a first adhesive layer. The first adhesive layer is bonded to the first thinned region and extends from the first thinned region to the second thinned region. A part of the first adhesive layer covers the first groove. Along the first direction, a length L1 by which the first adhesive layer is bonded to the first thinned region is less than a length L2 by which the first adhesive layer is bonded to the second thinned region.

Compared with the existing method in which the same length of adhesive tape is applied onto the two sides of the groove, this application sets L1 to be less than L2, thereby increasing the coverage area of the first adhesive layer on the second thinned region on the premise that the first adhesive layer completely covers the two sides of the first groove along the first direction, reducing the risk of lithium plating that occurs in the second thinned region, reducing the coverage area of the first adhesive layer on the first thinned region, and increasing the energy density of the battery.

In some embodiments of this application, 0 mm<L1≤5 mm, and 0.5 mm≤L2≤20 mm.

In some embodiments of this application, the first electrode plate further includes a second active material layer. The first current collector further includes a second surface. The second surface and the first surface are disposed opposite to each other along the second direction. The second active material layer includes a third part and a fourth part. The third part and the fourth part are disposed apart on the second surface along the first direction. A second groove is formed between the third part and the fourth part to expose the second surface. Along the first direction, a third thinned region is disposed at a position adjacent to the second groove in the third part. A fourth thinned region is disposed at a position adjacent to the second groove in the fourth part. Along the second direction, a thickness of the third thinned region is greater than a thickness of the fourth thinned region. The battery cell further includes a second adhesive layer. The second adhesive layer is bonded to the third thinned region and extends from the third thinned region to the fourth thinned region. A part of the second adhesive layer covers the second groove. Along the first direction, a length L3 by which the second adhesive layer is bonded to the third thinned region is greater than a length L4 by which the second adhesive layer is bonded to the fourth thinned region.

Compared with the existing method in which the same length of adhesive tape is applied onto the two sides of the groove, this application sets L3 to be greater than L4, thereby increasing the coverage area of the second groove on the third thinned region on the premise that the second adhesive layer completely covers the two sides of the second groove along the first direction, reducing the risk of lithium plating that occurs in the third thinned region, reducing the coverage area of the second adhesive layer on the fourth thinned region, and increasing the energy density of the battery.

In some embodiments of this application, 0.5 mm≤L3≤20 mm, and 0 mm<L4≤5 mm.

In some embodiments of this application, along the second direction, the third thinned region is opposite to the first thinned region, and the fourth thinned region is opposite to the second thinned region, so that the first adhesive layer and the second adhesive layer are staggered in the first direction.

In some embodiments of this application, along the second direction, a projection of the first groove overlaps with a projection of the second groove, so as to make it convenient to locate the first groove and the second groove during the preparation of the first electrode plate, simplify the preparation process of the electrode plate, and improve the production efficiency.

In some embodiments of this application, L2 is equal to L3, thereby further controlling the first adhesive layer and the second adhesive layer to be staggered in the first direction.

In some embodiments of this application, a difference between the length L1 by which the first adhesive layer is bonded to the first thinned region and the length L3 by which the second adhesive layer is bonded to the third thinned region is A, satisfying: 1 mm<|A|<15 mm. When |A|≤1 mm, the first adhesive layer and the second adhesive layer are basically aligned with each other, consistent with the existing adhesive affixing method. This setting ensures that the second adhesive layer covers the third thinned region, but increases the coverage area of the first adhesive layer on the first thinned region, thereby impairing the energy density of the battery. When |A| ≥15 mm, the first adhesive layer and the second adhesive layer are staggered from each other excessively. This setting ensures that the first adhesive layer covers the first thinned region, but may make the second adhesive layer cover other normal regions of the third part, thereby impairing the energy density of the battery.

In some embodiments of this application, a difference between the length L2 by which the first adhesive layer is bonded to the second thinned region and the length L4 by which the second adhesive layer is bonded to the fourth thinned region is B, satisfying: 1 mm<|B|<15 mm. When |B|≤1 mm, the first adhesive layer and the second adhesive layer are basically aligned with each other, consistent with the existing adhesive affixing method. This setting ensures that the first adhesive layer covers the second thinned region, but increases the coverage area of the second adhesive layer on the fourth thinned region, thereby impairing the energy density of the battery. When |B| ≥15 mm, the first adhesive layer and the second adhesive layer are staggered from each other excessively. This setting ensures that the second adhesive layer covers the fourth thinned region, but may make the first adhesive layer cover other normal regions of the second part, thereby impairing the energy density of the battery.

According to some embodiments of this application, the first electrode plate is a positive electrode plate or a negative electrode plate.

An embodiment of this application further provides a battery. The battery includes a housing and the battery cell disclosed in any one of the above embodiments. The battery cell is disposed in the housing.

An embodiment of this application further provides an electrical device. The electrical device includes the battery disclosed in any one of the above embodiments.

In the battery cell, battery, and electrical device of this application, along the first direction, the length by which the first adhesive layer is bonded to the first thinned region is less than the length by which the first adhesive layer is bonded to the second thinned region. Compared with the existing method in which the same length of adhesive tape is applied onto the two sides of the groove, this application sets L1 to be less than L2, thereby increasing the coverage area of the first adhesive layer on the second thinned region on the premise that the first adhesive layer completely covers the two sides of the first groove along the first direction, reducing the risk of lithium plating that occurs in the second thinned region, reducing the coverage area of the first adhesive layer on the first thinned region, and increasing the energy density of the battery.

### BRIEF DESCRIPTION OF DRAWINGS

FIG. 1 is a first schematic structural diagram of a battery cell according to an embodiment of this application;

FIG. 2 is a first schematic structural diagram of a first electrode plate in a battery cell according to an embodiment of this application;

FIG. 3 is a second schematic structural diagram of a battery cell according to an embodiment of this application;

FIG. 4 is a second schematic structural diagram of a first electrode plate in a battery cell according to an embodiment of this application;

FIG. 5 is a third schematic structural diagram of a battery cell according to an embodiment of this application;

FIG. 6 is a schematic structural diagram of a first electrode plate and a second electrode plate in a battery cell according to an embodiment of this application; and

FIG. 7 is a schematic structural diagram of an electrical device according to an embodiment of this application.

### LIST OF REFERENCE NUMERALS

battery cell 100
battery 200
electrical device 300
first electrode plate 10
first current collector 11
first surface 11a
second surface 11b
blank region 111
First active material layer 12
first part 121
first thinned region 121a
second part 122
second thinned region 122a
first groove 13
second active material layer 14
third part 141
third thinned region 141a
fourth part 142
fourth thinned region 142a
second groove 15
second electrode plate 20
Separator 30
first adhesive layer 41
second adhesive layer 42
third adhesive layer 51
fourth adhesive layer 52
first tab 61
second tab 62
device body 90
first direction X
second direction Z
third direction Y

This application is further described below with reference to the following specific embodiments and the foregoing drawings.

### DETAILED DESCRIPTION

The following describes the technical solutions in the embodiments of this application with reference to the drawings hereto. Evidently, the described embodiments are merely a part of but not all of the embodiments of this application.

It is hereby noted that a component considered to be “connected to” another component may be directly connected to the other component or may be connected to the other component through an intermediate component. A component considered to be “disposed on” another component may be directly disposed on the other component or may be disposed on the other component through an intermediate component.

Unless otherwise defined, all technical and scientific terms used herein bear the same meanings as what is normally understood by a person skilled in the technical field of this application. The terms used in the specification of this application are merely intended to describe specific embodiments but not to limit this application. The term “and/or” used herein includes any and all combinations of one or more relevant items enumerated. The terms “vertical”, “horizontal”, “left”, “right”, “top”, “bottom”, and similar expressions are used herein merely for ease of description but not for limiting this application.

Understandably, when two components are arranged parallel or perpendicular to each other along the same direction, a tolerable angle may exist between the two components. The angle between two components permits a tolerance of 0 to ±10%, and a measured value of the angle between the two components may be greater than, equal to, or less than the nominal value with a tolerance of 0 to ±10%.

This application relates to a thinned region of an active material layer. The following is a brief description of the thinned region mentioned in this application: In a production process of a battery, a slurry is usually extruded and applied onto a current collector to form an active material layer. Depending on the need, some positions of the current collector do not need to be coated with the slurry, and the slurry may be applied intermittently. The intermittent coating may be controlled by a coating valve. The coating valve is opened and closed alternately to implement the coating. In a period before the slurry flows out steadily and after the coating valve is opened, the slurry applied onto the current collector is unsteady. A region formed by the slurry applied onto the current collector in this period is called a thinned region. The thickness of the thinned region is generally smaller than the thickness of a normal region.

In addition, at the moment of intermittent opening and closing, the hydraulic pressure of the slurry in a pipeline is unstable, thereby usually making the thickness nonuniform between a head region and a tail region.

An embodiment of this application provides a battery cell, including a first electrode plate. The first electrode plate includes a first current collector and a first active material layer. The first current collector includes a first surface. The first active material layer includes a first part and a second part. A length direction of the first current collector unwound is a first direction. The first part and the second part are disposed apart on the first surface along the first direction. A first groove is formed between the first part and the second part to expose the first surface. Along the first direction, a first thinned region is disposed at a position adjacent to the first groove in the first part, and a second thinned region is disposed at a position adjacent to the first groove in the second part. A thickness direction of the first current collector is a second direction. Along the second direction, a thickness of the second thinned region is greater than a thickness of the first thinned region. The battery cell further includes a first adhesive layer. The first adhesive layer is bonded to the first thinned region and extends from the first thinned region to the second thinned region. A part of the first adhesive layer covers the first groove. Along the first direction, a length L1 by which the first adhesive layer is bonded to the first thinned region is less than a length L2 by which the first adhesive layer is bonded to the second thinned region.

In the above battery cell, compared with the existing method in which the same length of adhesive tape is applied onto the two sides of the groove, this application sets L1 to be less than L2, thereby increasing the coverage area of the first adhesive layer on the second thinned region on the premise that the first adhesive layer completely covers the two sides of the first groove along the first direction, reducing the risk of lithium plating that occurs in the second thinned region, reducing the coverage area of the first adhesive layer on the first thinned region, and increasing the energy density of the battery.

The following further describes the embodiments of this application with reference to drawings.

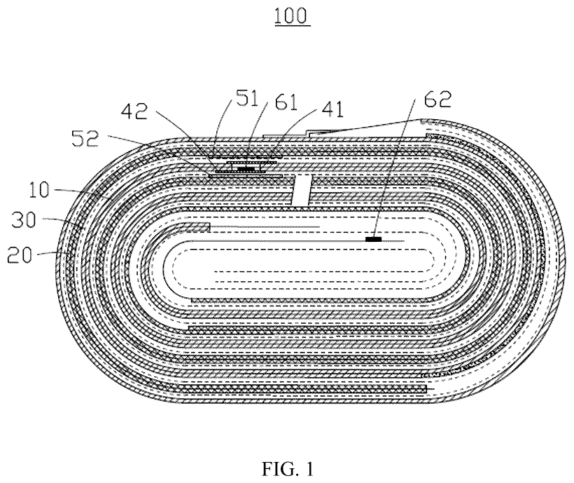

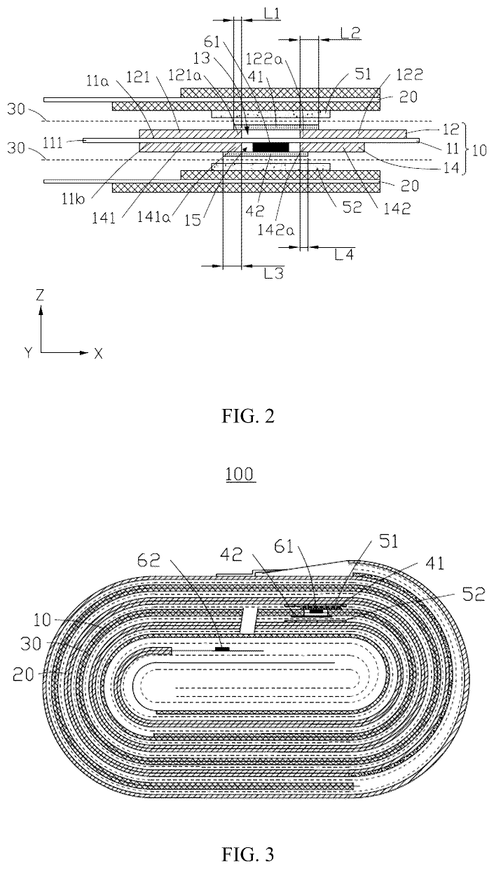

Referring to FIG. 1 and FIG. 2 together, an embodiment of this application provides a battery cell 100. The battery cell includes a first electrode plate 10, a second electrode plate 20, and a separator 30. The separator 30 is located between the first electrode plate 10 and the second electrode plate 20. The polarity of the first electrode plate 10 is opposite to the polarity of the second electrode plate 20. In some embodiments, the first electrode plate 10, the second electrode plate 20, and the separator 30 are wound in sequence.

Understandably, in some embodiments, the first electrode plate 10, the second electrode plate 20, and the separator 30 are stacked in sequence.

In some embodiments, the first electrode plate 10 includes a first current collector 11 and a first active material layer 12. The first current collector 11 includes a first surface 11a. The first active material layer 12 allows deintercalation and intercalation of lithium ions. The first current collector 11 conducts a current generated by electrochemical reactions to an external circuit, thereby converting chemical energy into electrical energy.

The first active material layer 12 includes a first part 121 and a second part 122. A length direction of the first current collector 11 unwound is a first direction X, and a width direction of the first current collector 11 unwound is a third direction Y. The “length direction” and the “width direction” of the first current collector 11 are two dimensions of the surface of the first current collector 11, respectively. The length direction means a major dimension direction (that is, the direction in which the size is relatively large). The width direction means a minor dimension direction (that is, the direction in which the size is relatively small). Generally, the length direction is in line with the direction in which the first active material layer 12 is applied, and is also in line with the winding direction. The width direction is perpendicular to the length direction.

The first part 121 and the second part 122 are disposed apart on the first surface 11a along a first direction X. A first groove 13 is formed between the first part 121 and the second part 122 to expose the first surface 11a. Along the third direction Y, the first groove 13 runs through the first active material layer. The first groove 13 is configured to accommodate components such as a tab. A part of the first surface 11a, which is located in the first groove 13, is configured to be electrically connected to the components such as the tab.

Along the first direction X, a first thinned region 121a is disposed at a position adjacent to the first groove 13 in the first part 121, and a second thinned region 122a is disposed at a position adjacent to the first groove 13 in the second part 122. A thickness direction of the first current collector 11 is a second direction Z. Along the second direction Z, the thickness of the first thinned region 121a is less than the thickness of other normal regions in the first part 121. The thickness of the second thinned region 122a is less than the thickness of other normal regions in the second part 122. In addition, the thickness of the second thinned region 122a is greater than the thickness of the first thinned region 121a.

The battery cell 100 further includes a first adhesive layer 41. The first adhesive layer 41 is bonded to the first thinned region 121a and extends from the first thinned region 121a to the second thinned region 122a. A part of the first adhesive layer 41 covers the first groove 13. Specifically, along the second direction Z, a projection of the first thinned region 121a, a projection of the first groove 13, and a projection of the second thinned region 122a are all located within a projection of the first adhesive layer 41.

A part, bonded to the first thinned region 121a, of the first adhesive layer 41 is configured to dielectrically isolate the first thinned region 121a from a region oriented toward the first thinned region 121a on the second electrode plate 20, so as to reduce the risk of lithium plating that occurs in the first thinned region 121a. The part, covering the first groove 13, of the first adhesive layer 41 is configured to dielectrically isolate the first surface 11a exposed in the first groove 13 from the component connected in the first groove 13. A part, bonded to the second thinned region 122a, of the first adhesive layer 41 is configured to dielectrically isolate the second thinned region 122a from a region oriented toward the second thinned region 122a on the second electrode plate 20, so as to reduce the risk of lithium plating that occurs in the second thinned region 122a.

Because the thickness of the second thinned region 122a is greater than the thickness of the first thinned region 121a, the second thinned region 122a can provide more lithium ions during charging and discharging, thereby making lithium plating more prone to occur in the second thinned region 122a. Along the first direction X, a length L1 by which the first adhesive layer 41 is bonded to the first thinned region 121a is less than a length L2 by which the first adhesive layer 41 is bonded to the second thinned region 122a. Compared with the existing method in which the same length of adhesive tape is applied onto the two sides of the groove, this application sets L1 to be less than L2, thereby increasing the coverage area of the first adhesive layer 41 on the second thinned region 122a on the premise that the first adhesive layer 41 completely covers the two sides of the first groove 13 along the first direction X, reducing the risk of lithium plating that occurs in the second thinned region 122a, reducing the coverage area of the first adhesive layer 41 on the first thinned region 121a, and increasing the energy density of the battery. In addition, the above setting reduces the amount of the first adhesive layer 41 that needs to be used, and reduces the production cost.

In some embodiments, 0 mm<L1≤5 mm. Optionally, L1 may be 0.5 mm, 1 mm, 1.5 mm, 2 mm, 2.5 mm, 3 mm, 3.5 mm, 4 mm, 4.5 mm, 5 mm, or a value falling within a range formed by any two thereof. 0.5 mm≤L2≤20 mm. Optionally, L2 may be 0.5 mm, 1 mm, 2.5 mm, 5 mm, 7.5 mm, 10 mm, 12.5 mm, 15 mm, 17.5 mm, 20 mm, or a value falling within a range formed by any two thereof.

Still referring to FIG. 1 and FIG. 2, in some embodiments, the first electrode plate 10 further includes a second active material layer 14. The first current collector 11 further includes a second surface 11b. The second surface 11b and the first surface 11a are disposed opposite to each other along the second direction Z. The second active material layer 14 and the first active material layer 12 are of the same polarity, and allow deintercalation and intercalation of lithium ions.

The second active material layer 14 includes a third part 141 and a fourth part 142. The third part 141 and the fourth part 142 are disposed apart on the second surface 11b along a first direction X. A second groove 15 is formed between the third part 141 and the fourth part 142 to expose the second surface 11b. The second groove 15 is configured to accommodate components such as a tab. A part of the second surface 11b, which is located in the second groove 15, is configured to be electrically connected to the components such as the tab.

Along the first direction X, a third thinned region 141a is disposed at a position adjacent to the second groove 15 in the third part 141. A fourth thinned region 142a is disposed at a position adjacent to the second groove 15 in the fourth part 142. Along the second direction Z, the thickness of the third thinned region 141a is greater than the thickness of the fourth thinned region 142a.

The battery cell 100 further includes a second adhesive layer 42. The second adhesive layer 42 is bonded to the third thinned region 141a and extends from the third thinned region 141a to the fourth thinned region 142a. A part of the second adhesive layer 42 covers the second groove 15. Specifically, along the second direction Z, a projection of the third thinned region 141a, a projection of the second groove 15, and a projection of the fourth thinned region 142a are all located within a projection of the second adhesive layer 42.

A part, bonded to the third thinned region 141a, of the second adhesive layer 42 is configured to dielectrically isolate the third thinned region 141a from a region oriented toward the third thinned region 141a on the second electrode plate 20, so as to reduce the risk of lithium plating that occurs in the third thinned region 141a. The part, covering the second groove 15, of the second adhesive layer 42 is configured to dielectrically isolate the second surface 11a exposed in the second groove 15 from the component connected in the second groove 15. A part, bonded to the fourth thinned region 142a, of the second adhesive layer 42 is configured to dielectrically isolate the fourth thinned region 142a from a region oriented toward the fourth thinned region 142a on the second electrode plate 20, so as to reduce the risk of lithium plating that occurs in the fourth thinned region 142a.

Because the thickness of the third thinned region 141a is greater than the thickness of the fourth thinned region 142a, the third thinned region 141a can provide more lithium ions during charging and discharging, thereby making lithium plating more prone to occur in the third thinned region 141a. Along the first direction X, a length L3 by which the second adhesive layer 42 is bonded to the third thinned region 141a is greater than a length L4 by which the second adhesive layer 42 is bonded to the fourth thinned region 142a. Compared with the existing method in which the same length of adhesive tape is applied onto the two sides of the groove, this application sets L3 to be greater than L4, thereby increasing the coverage area of the second groove 15 on the third thinned region 141a on the premise that the second adhesive layer 42 completely covers the two sides of the second groove 15 along the first direction X, reducing the risk of lithium plating that occurs in the third thinned region 141a, reducing the coverage area of the second adhesive layer 42 on the fourth thinned region 142a, and increasing the energy density of the battery.

In some embodiments, 0.5 mm≤L3≤20 mm. Optionally, L3 may be 0.5 mm, 1 mm, 2.5 mm, 5 mm, 7.5 mm, 10 mm, 12.5 mm, 15 mm, 17.5 mm, 20 mm, or a value falling within a range formed by any two thereof. 0 mm<L4≤5 mm. Optionally, L4 may be 0.5 mm, 1 mm, 1.5 mm, 2 mm, 2.5 mm, 3 mm, 3.5 mm, 4 mm, 4.5 mm, 5 mm, or a value falling within a range formed by any two thereof.

Still referring to FIG. 1 and FIG. 2, in some embodiments, along the second direction, the third thinned region 141a is opposite to the first thinned region 121a, and the fourth thinned region 142a is opposite to the second thinned region 122a, so that the first adhesive layer 41 and the second adhesive layer 42 are staggered in the first direction X. Specifically, along the first direction X, the length by which the second adhesive layer 42 is bonded to the third thinned region 141a exceeds the length by which the first adhesive layer 41 is bonded to the first thinned region 121a, and the length by which the first adhesive layer 41 is bonded to the second thinned region 122a exceeds the length by which the second adhesive layer 42 is bonded to the fourth thinned region 142a. Compared with the existing method in which the adhesive tape applied onto one of the two sides of the groove is flush with the adhesive tape applied onto the other side, this application reduces the coverage area of the first adhesive layer 41 on the first thinned region 121a, and reduces the coverage area of the second adhesive layer 42 on the fourth thinned region 142a, thereby increasing the energy density of the battery while reducing the risk of lithium plating.

Still referring to FIG. 1 and FIG. 2, in some embodiments, along the second direction Z, a projection of the first groove 13 overlaps a projection of the second groove 15, so as to make it convenient to locate the first groove 13 and the second groove 15 during the preparation of the first electrode plate 10, simplify the preparation process of the electrode plate, and improve the production efficiency. Specifically, along the first direction X, the third thinned region 141a and the first thinned region 121a are located on one side of the first groove 13, and the fourth thinned region 142a and the second thinned region 122a are located on the other side of the first groove 13. Understandably, in an alternative manner, the second groove 15 serves as a reference in place of the first groove 13, the third thinned region 141a and the first thinned region 121a are located on one side of the second groove 15, and the fourth thinned region 142a and the second thinned region 122a are located on the other side of the second groove 15.

In some embodiments, L2=L3, and/or, L1=L4. When L2=L3 and L1=L4, the first adhesive layer 41 and the second adhesive layer 42 are further controlled to be staggered in the first direction X.

Still referring to FIG. 1 and FIG. 2, in some embodiments, a difference between the length L1 by which the first adhesive layer 41 is bonded to the first thinned region 121a and the length L3 by which the second adhesive layer 42 is bonded to the third thinned region 141a is A, satisfying: 1 mm<|A|<15 mm. When |A|≤1 mm, the first adhesive layer and the second adhesive layer are basically aligned with each other, consistent with the existing adhesive affixing method. This setting ensures that the second adhesive layer 42 covers the third thinned region 141a, but increases the coverage area of the first adhesive layer 41 on the first thinned region 121a, thereby impairing the energy density of the battery. When |A|≥15 mm, the first adhesive layer and the second adhesive layer are staggered from each other excessively. This setting ensures that the first adhesive layer 41 covers the first thinned region 121a, but may make the second adhesive layer 42 cover other normal regions of the third part 141, thereby impairing the energy density of the battery.

Optionally, |A| may be 1.5 mm, 2 mm, 3 mm, 4 mm, 5 mm, 6 mm, 7 mm, 8 mm, 9 mm, 10 mm, 11 mm, 12 mm, 13 mm, 14.5 mm, or a value falling within a range formed by any two thereof.

In some embodiments, a difference between the length L2 by which the first adhesive layer 41 is bonded to the second thinned region 122a and the length L4 by which the second adhesive layer 42 is bonded to the fourth thinned region 142a is B, satisfying: 1 mm<|B|<15 mm. When |B|≤1 mm, the first adhesive layer and the second adhesive layer are basically aligned with each other, consistent with the existing adhesive affixing method. This setting ensures that the first adhesive layer 41 covers the second thinned region 122a, but increases the coverage area of the second adhesive layer 42 on the fourth thinned region 142a, thereby impairing the energy density of the battery. When |B|≥15 mm, the first adhesive layer and the second adhesive layer are staggered from each other excessively. This setting ensures that the second adhesive layer 42 covers the fourth thinned region 142a, but may make the first adhesive layer 41 cover other normal regions of the second part 122, thereby impairing the energy density of the battery.

Optionally, |B| may be 1.5 mm, 2 mm, 3 mm, 4 mm, 5 mm, 6 mm, 7 mm, 8 mm, 9 mm, 10 mm, 11 mm, 12 mm, 13 mm, 14.5 mm, or a value falling within a range formed by any two thereof.

Still referring to FIG. 1 and FIG. 2, in some embodiments, the battery cell 100 further includes a first tab 61. At least a part of the first tab 61 is located in the first groove 13 or the second groove 15, and is electrically connected to the first current collector 11. Specifically, at least a part of the first tab 61 is electrically connected to the part, located in the first groove 13, of the first surface 11a; or, at least a part of the first tab 61 is electrically connected to the part, located in the second groove 15, of the second surface 11b. With the first tab 61 accommodated in the first groove 13 or the second groove 15, the stability of the electrical connection is improved.

In some embodiments, the battery cell 100 further includes a third adhesive layer 51. The third adhesive layer 51 is bonded to the region oriented toward the first adhesive layer 41 on the second electrode plate 20, so as to dielectrically isolate the region covered by the first adhesive layer 41 on the first electrode plate 10 from the region oriented toward the first adhesive layer 41 on the second electrode plate 20, thereby reducing the risk of lithium plating.

In some embodiments, along the first direction X, the two sides of the third adhesive layer 51 extend beyond the two sides of the first adhesive layer 41. In this way, when a displacement occurs between the first electrode plate 10 and the second electrode plate 20 in a collision or other circumstances of the battery cell 100, the third adhesive layer 51 can still serve as an isolator, thereby improving the stability of the insulation.

In some embodiments, the battery cell 100 further includes a fourth adhesive layer 52. The fourth adhesive layer 52 is bonded to the region oriented toward the second adhesive layer 42 on the second electrode plate 20, so as to dielectrically isolate the region covered by the second adhesive layer 42 on the first electrode plate 10 from the region oriented toward the second adhesive layer 42 on the second electrode plate 20, thereby reducing the risk of lithium plating.

In some embodiments, along the first direction X, the two sides of the fourth adhesive layer 52 extend beyond the two sides of the second adhesive layer 42. In this way, when a displacement occurs between the first electrode plate 10 and the second electrode plate 20 in a collision or other circumstances of the battery cell 100, the fourth adhesive layer 52 can still serve as an insulator, thereby improving the stability of the insulation.

In some embodiments, the first electrode plate 10 is a positive electrode plate, and the second electrode plate 20 is a negative electrode plate.

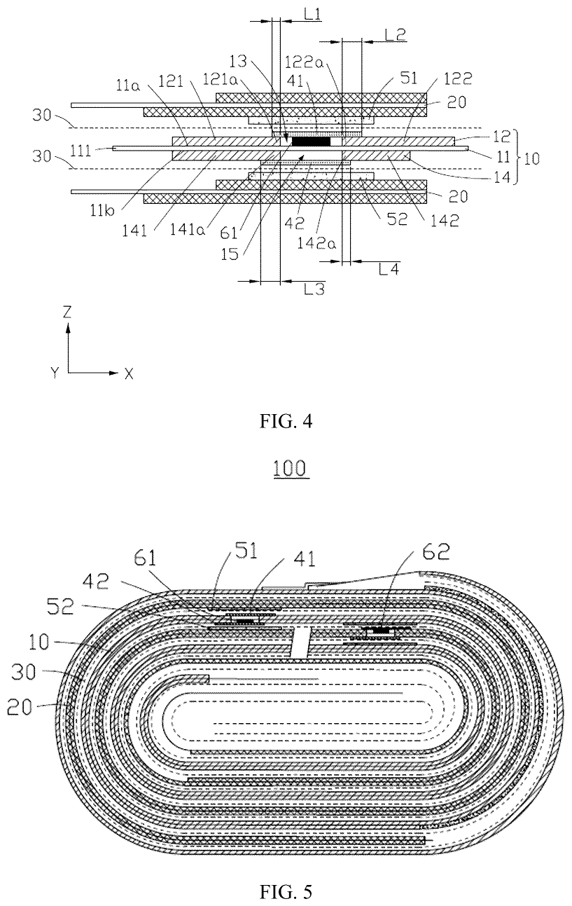

Referring to FIG. 3 and FIG. 4 together, understandably, in some embodiments, when the first electrode plate 10 is a negative electrode plate, the second electrode plate 20 is a positive electrode plate.

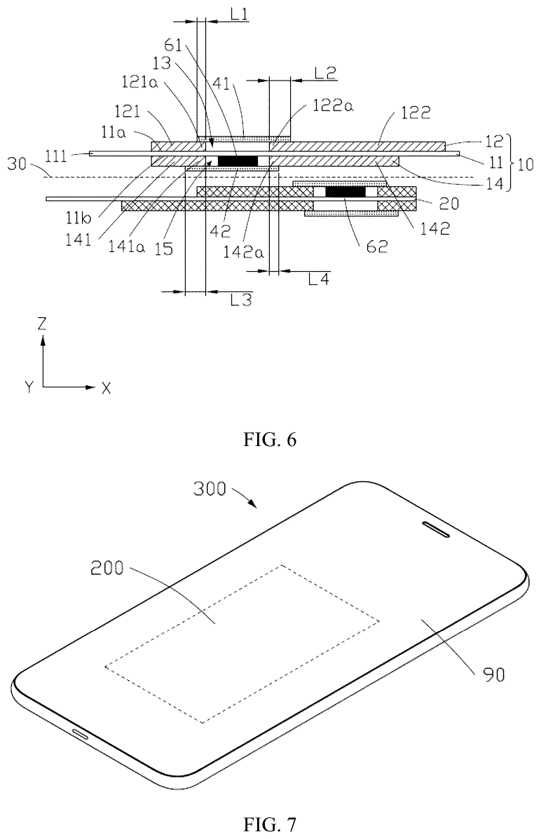

Referring to FIG. 5 and FIG. 6 together, understandably, in some embodiments, both the positive electrode plate and the negative electrode plate employ the structural design in the above embodiment, thereby comprehensively increasing the energy density of the battery while reducing the risk of lithium plating.

This application is described below with reference to specific embodiments.

First Embodiment: Referring to FIG. 1 and FIG. 2 together, the first electrode plate 10 is a negative electrode plate, the second electrode plate 20 is a positive electrode plate, and at least a part of the first tab 61 is located in the second groove 15. L1=L4=2 mm; L2=L3=9 mm; |A|=|B|=7 mm. A blank region 111 is disposed at a start end of the first current collector 11, and the blank region is not coated with the first active material layer 12 or the second active material layer 14. Along the first direction X, the length of the blank region 111 is 15 mm. The length of the third adhesive layer 51 and the length of the fourth adhesive layer 52 are both 11 mm.

Second Embodiment: Referring to FIG. 3 and FIG. 4 together, the first electrode plate 10 is a positive electrode plate, the second electrode plate 20 is a negative electrode plate, and at least a part of the first tab 61 is located in the first groove 13. L1=L4=2 mm; L2=L3=12 mm; |A|=|B|=10 mm. A blank region 111 is disposed at a start end of the first current collector 11, and the blank region is not coated with the first active material layer 12 or the second active material layer 14. Along the first direction X, the length of the blank region 111 is 15 mm.

Third Embodiment: Referring to FIG. 5 and FIG. 6 together, the first electrode plate 10 is a positive electrode plate, and the second electrode plate 20 is a negative electrode plate. The second electrode plate 20 and the first electrode plate 10 are of different polarities but assume the same structure. The structure of the first electrode plate 10 is described as an example, and the structure of the second electrode plate 20 may be learned by referring to the description about the first electrode plate 10 and is not detailed herein.

At least a part of the first tab 61 is located in the second groove 15 of the first electrode plate 10. L1=L4=2 mm; L2=L3=9 mm; |A|=|B|=7 mm. The battery cell 100 further includes a second tab 62. At least a part of the second tab 62 is located in the first groove 13 of the second electrode plate 20. L1=L4=12 mm; L2=L3=2 mm; |A|=|B|=10 mm.

Referring to FIG. 7, an embodiment of this application further provides a battery 200. The battery includes a housing and the battery cell 100 disclosed in any one of the above embodiments. The battery cell 100 is accommodated in the housing (not shown in the drawing).

Still referring to FIG. 7, an embodiment of this application further provides an electrical device 300. The electrical device includes the battery 200 disclosed in the above embodiment. The electrical device 300 further includes a device body 90. The battery 200 is electrically connected to the device body 90 to supply power to the device body 90. In some embodiments, the electrical device 300 may be an electronic device such as a mobile phone or tablet computer, or may be a mobile device such as an electric vehicle.

In the battery cell 100, the battery 200 containing the battery cell 100, and the electrical device 300, along the first direction X, the length L1 by which the first adhesive layer 41 is bonded to the first thinned region 121a is less than the length L2 by which the first adhesive layer 41 is bonded to the second thinned region 122a. Compared with the existing method in which the same length of adhesive tape is applied onto the two sides of the groove, this application sets L1 to be less than L2, thereby increasing the coverage area of the first adhesive layer 41 on the second thinned region 122a on the premise that the first adhesive layer 41 completely covers the two sides of the first groove 13 along the first direction X, reducing the risk of lithium plating that occurs in the second thinned region 122a, reducing the coverage area of the first adhesive layer 41 on the first thinned region 121a, and increasing the energy density of the battery.

In addition, a person skilled in the art may make other variations to this application without departing from the essence of this application. The variations made based on the essence of this application still fall within the protection scope of this application.

1. A battery cell, comprising a first electrode plate, wherein,
the first electrode plate comprises a first current collector and a first active material layer;
the first current collector comprises a first surface;
the first active material layer comprises a first part and a second part;
a length direction of the first current collector is a first direction, the first part and the second part are disposed spaced apart from each other on the first surface along the first direction;
a first groove is formed between the first part and the second part to expose the first surface;
along the first direction, a first thinned region is disposed at a position adjacent to the first groove in the first part;
a second thinned region is disposed at a position adjacent to the first groove in the second part;
a thickness direction of the first current collector is a second direction; along the second direction, a thickness of the second thinned region is greater than a thickness of the first thinned region;
the battery cell further comprises a first adhesive layer;
the first adhesive layer is bonded to the first thinned region and extends from the first thinned region to the second thinned region;
a part of the first adhesive layer covers the first groove; and
along the first direction, a length L1 by which the first adhesive layer is bonded to the first thinned region is less than a length L2 by which the first adhesive layer is bonded to the second thinned region.

2. The battery cell according to claim 1, wherein,
0 mm<L1≤5 mm; and
0.5 mm≤L2≤20 mm.

3. The battery cell according to claim 1, wherein,
the first electrode plate further comprises a second active material layer;
the first current collector further comprises a second surface;
the second surface and the first surface are disposed opposite to each other along the second direction;
the second active material layer comprises a third part and a fourth part;
the third part and the fourth part are disposed spaced apart from each other on the second surface along the first direction;
a second groove is formed between the third part and the fourth part to expose the second surface;
along the first direction, a third thinned region is disposed at a position adjacent to the second groove in the third part;
a fourth thinned region is disposed at a position adjacent to the second groove in the fourth part;
along the second direction, a thickness of the third thinned region is greater than a thickness of the fourth thinned region;
the battery cell further comprises a second adhesive layer;
the second adhesive layer is bonded to the third thinned region and extends from the third thinned region to the fourth thinned region;
a part of the second adhesive layer covers the second groove; and
along the first direction, a length L3 by which the second adhesive layer is bonded to the third thinned region is greater than a length L4 by which the second adhesive layer is bonded to the fourth thinned region.

4. The battery cell according to claim 3, wherein,
0.5 mm≤L3≤20 mm, and
0 mm<L4≤5 mm.

5. The battery cell according to claim 3, wherein,
along the second direction, the third thinned region is opposite to the first thinned region; and
along the second direction, the fourth thinned region is opposite to the second thinned region.

6. The battery cell according to claim 3, wherein, viewed along the second direction, the first groove overlaps with the second groove.

7. The battery cell according to claim 3, wherein, L2 is equal to L3.

8. The battery cell according to claim 3, wherein, a difference between the length L1 by which the first adhesive layer is bonded to the first thinned region and the length L3 by which the second adhesive layer is bonded to the third thinned region is A, 1 mm<|A|<15 mm.

9. The battery cell according to claim 3, wherein, a difference between the length L2 by which the first adhesive layer is bonded to the second thinned region and the length L4 by which the second adhesive layer is bonded to the fourth thinned region is B, 1 mm<|B|<15 mm.

10. The battery cell according to claim 1, wherein, the first electrode plate is a positive electrode plate or a negative electrode plate.

11. A battery, comprising a housing and a battery cell disposed in the housing, wherein,
the battery cell comprises a first electrode plate;
the first electrode plate comprises a first current collector and a first active material layer;
the first current collector comprises a first surface;
the first active material layer comprises a first part and a second part;
a length direction of the first current collector is a first direction, the first part and the second part are disposed spaced apart from each other on the first surface along the first direction;
a first groove is formed between the first part and the second part to expose the first surface;
along the first direction, a first thinned region is disposed at a position adjacent to the first groove in the first part;
a second thinned region is disposed at a position adjacent to the first groove in the second part;
a thickness direction of the first current collector is a second direction; along the second direction, a thickness of the second thinned region is greater than a thickness of the first thinned region;
the battery cell further comprises a first adhesive layer;
the first adhesive layer is bonded to the first thinned region and extends from the first thinned region to the second thinned region;
a part of the first adhesive layer covers the first groove; and
along the first direction, a length L1 by which the first adhesive layer is bonded to the first thinned region is less than a length L2 by which the first adhesive layer is bonded to the second thinned region.

12. The battery according to claim 11, wherein,
0 mm<L1≤5 mm; and
0.5 mm≤L2≤20 mm.

13. The battery according to claim 11, wherein,
the first electrode plate further comprises a second active material layer;
the first current collector further comprises a second surface;
the second surface and the first surface are disposed opposite to each other along the second direction;
the second active material layer comprises a third part and a fourth part;
the third part and the fourth part are disposed spaced apart from each other on the second surface along the first direction;
a second groove is formed between the third part and the fourth part to expose the second surface;
along the first direction, a third thinned region is disposed at a position adjacent to the second groove in the third part;
a fourth thinned region is disposed at a position adjacent to the second groove in the fourth part;
along the second direction, a thickness of the third thinned region is greater than a thickness of the fourth thinned region;
the battery cell further comprises a second adhesive layer;
the second adhesive layer is bonded to the third thinned region and extends from the third thinned region to the fourth thinned region;
a part of the second adhesive layer covers the second groove; and
along the first direction, a length L3 by which the second adhesive layer is bonded to the third thinned region is greater than a length L4 by which the second adhesive layer is bonded to the fourth thinned region.

14. The battery according to claim 13, wherein,
0.5 mm≤L3≤20 mm, and
0 mm<L4≤5 mm.

15. The battery according to claim 13, wherein,
along the second direction, the third thinned region is opposite to the first thinned region; and
along the second direction, the fourth thinned region is opposite to the second thinned region.

16. The battery according to claim 13, wherein, viewed along the second direction, the first groove overlaps with the second groove.

17. The battery according to claim 13, wherein, L2 is equal to L3.

18. The battery according to claim 13, wherein, a difference between the length L1 by which the first adhesive layer is bonded to the first thinned region and the length L3 by which the second adhesive layer is bonded to the third thinned region is A, 1 mm<|A|<15 mm.

19. The battery according to claim 13, wherein, a difference between the length L2 by which the first adhesive layer is bonded to the second thinned region and the length L4 by which the second adhesive layer is bonded to the fourth thinned region is B, 1 mm<|B|<15 mm.

20. An electrical device, wherein, the electrical device comprises the battery according to claim 11.
